(19) United States
(12) Patent Application Publication
(10) Pub. No.: US 2016/0243690 A1
(43) Pub. Date: Aug. 25, 2016

(54) VARIABLE DAMPING SYSTEM FOR A POWER CELL OF A HYDRAULIC HAMMER

(71) Applicant: Caterpillar Inc., Peoria, IL (US)

(72) Inventors: Steven B. Ellis, Hewitt, TX (US); Stephen P. Amborski, China Spring, TX (US); Lauritz P. Pillers, II, McGregor, TX (US)

(73) Assignee: Caterpillar Inc., Peoria, IL (US)

(21) Appl. No.: 14/625,816

(22) Filed: Feb. 19, 2015

(51) Int. Cl. B25D 17/24; F16F 9/10; F16F 9/04; B25D 9/00

(52) U.S. Cl. CPC B25D 17/245; B25D 9/00; F16F 9/10; F16F 9/04

(57) ABSTRACT

A variable damping system for a power cell of a hydraulic hammer is disclosed. The hydraulic hammer has a housing and a mounting bracket disposed on a top side of the housing. The variable damping system includes an expandable bladder that is positioned between the power cell and an underside of the mounting bracket. The expandable bladder is configured to receive a supply of pressurized fluid and maintain a pre-determined volume of pressurized fluid therein.

### TECHNICAL FIELD

The present disclosure generally relates to a damping system. More particularly, the present disclosure relates to a variable damping system for a power cell of a hydraulic hammer.

### BACKGROUND

Hydraulic power hammers typically include a power cell enclosed within a housing. Moreover, the hydraulic hammers may employ one or more dampers disposed between the power cell and the housing. For reference, U.S. Pat. No. 5,419,404 relates to a hydraulic impact hammer comprising a protective casing made of two side plates, and provided with attenuation elements for eliminating the noise and vibration caused by the impact hammer.

Although the dampers or attenuation elements are provided to attenuate noise and/or vibrations experienced during operation of the hydraulic hammers, the amount of damping accomplished with use of such dampers or attenuation elements is fixed. In many cases, an operator controlling the hydraulic hammer via a control implement may wish to vary this amount of damping depending on how he wishes to feel the responsiveness of the hydraulic hammers in the control implement. Hence, there is a need for a system that provides an operator of a hydraulic hammer with the ability to vary the amount of damping in the hydraulic hammer.

### SUMMARY OF THE DISCLOSURE

In an aspect of the present disclosure, a variable damping system for a power cell of a hydraulic hammer is disclosed. The hydraulic hammer has a housing and a mounting bracket disposed on a top side of the housing. The variable damping system includes an expandable bladder that is positioned between the power cell and an underside of the mounting bracket. The expandable bladder is configured to receive a supply of pressurized fluid and maintain a pre-determined volume of pressurized fluid therein.

In another aspect of the present disclosure, a hydraulic hammer includes a housing, a mounting bracket disposed on a top side of the housing, and a power cell disposed within the housing. The hydraulic hammer further includes a variable damping system for damping vibrations during operation of the power cell. The variable damping system includes an expandable bladder that is positioned between the power cell and an underside of the mounting bracket. The expandable bladder is configured to receive a supply of pressurized fluid and maintain a pre-determined volume of pressurized fluid therein.

In yet another aspect of the present disclosure, a machine for drilling work surfaces includes a hydraulic hammer, a control implement that is operable to control functions of the hydraulic hammer, and a variable damping system that is configured to damp vibrations from the hydraulic hammer to the control implement in at least one of an underdamped state, a critically damped state, and an overdamped state.

The hydraulic hammer has a power cell that is enclosed within a housing. The hydraulic hammer also includes a mounting bracket that is disposed on a top side of the housing. The control implement is coupled to the power cell of the hydraulic hammer. The variable damping system includes an expandable bladder that is positioned between the power cell and an underside of the mounting bracket. The expandable bladder is configured to maintain a pre-determined volume of pressurized fluid therein. The variable damping system further includes a pump that is disposed in fluid communication with the bladder. The pump is configured to supply the pre-determined volume of pressurized fluid to the bladder.

Other features and aspects of this disclosure will be apparent from the following description and the accompanying drawings.

### BRIEF DESCRIPTION OF THE DRAWINGS

FIG. 1 is a diagrammatic view of an exemplary machine using a hydraulic hammer in accordance with an embodiment of the present disclosure;

FIG. 2 is a schematic view of the hydraulic hammer and a control implement in accordance with an embodiment of the present disclosure;

FIG. 3 is an exploded view of the hydraulic hammer in accordance with an embodiment of the present disclosure; and

FIG. 4 is an exploded view of the hydraulic hammer in accordance with another embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

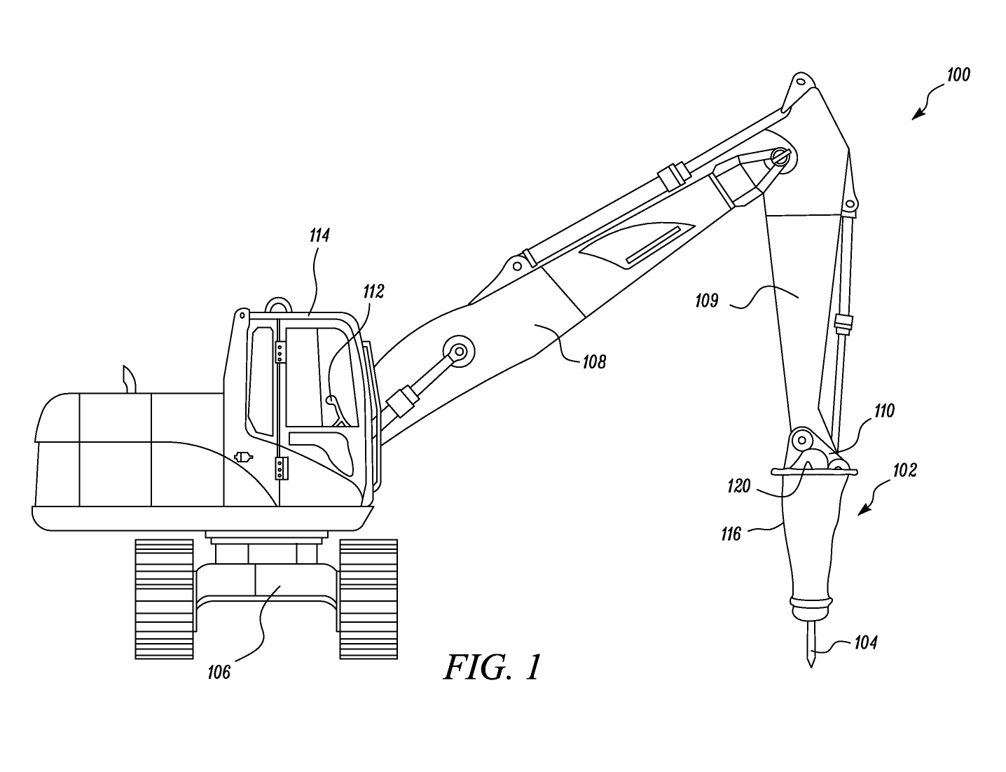

FIG. 1 shows a diagrammatic view of an exemplary machine 100. The machine employs a hydraulic hammer 102 shown in accordance with an embodiment of the present disclosure. The hydraulic hammer 102 includes a pecking tool 104 that is configured to break rocks and penetrate ground surfaces.

In the illustrated embodiment of FIG. 1, the machine 100 is embodied in the form of a tracked industrial vehicle such as an excavator, wherein the hydraulic hammer 102 is mounted to replace an excavator bucket (not shown) previously associated with the excavator. Consequently, the hydraulic hammer 102 may be beneficially operated by the excavator's hydraulics. However, it can be optionally contemplated to use other types of machines and carriers to power the hydraulic hammer 102 of the present disclosure.

As shown in FIG. 1, the machine 100 includes a frame 106; one or more linkages 108, 109; and a mounting bracket 110 that pivotally connects the hydraulic hammer 102 to the linkage 109. The linkages 108, 109 may be articulated relative to the frame 106 in order to change an orientation and/or position of the hydraulic hammer 102 with respect to a ground surface. The machine 100 includes a control implement 112 that may be located within a cab 114. The control implement 112 may be used by an operator to control functions of the hydraulic hammer 102.

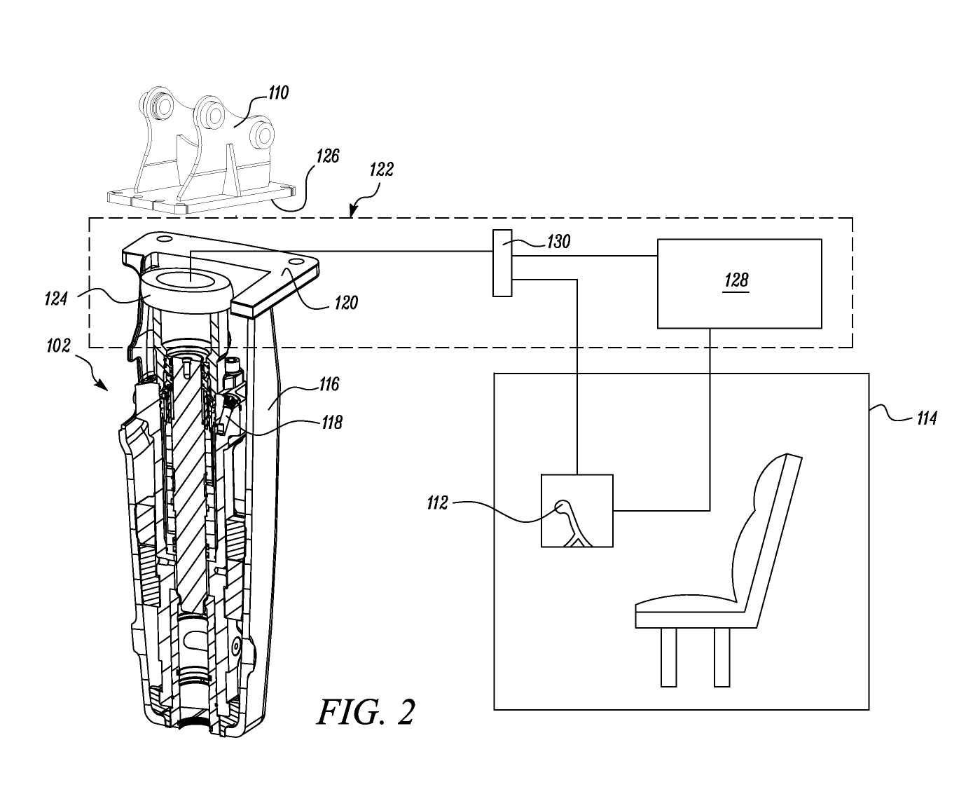

Referring to FIG. 2, a schematic view of the hydraulic hammer 102 and the control implement 112 is rendered in accordance with an embodiment of the present disclosure. The hydraulic hammer 102 includes a housing 116 that is configured to enclose a power cell 118 therein. Moreover, the mounting bracket 110 is disposed on a top side 120 of the housing 116. The power cell 118 is configured to drive the pecking tool 104 of the hydraulic hammer 102 so that the pecking tool 104 may perform functions that are consistent with the present disclosure. The present disclosure relates to a variable damping system 122 that is provided for damping vibrations during operation of the hydraulic hammer 102.

As shown in FIG. 2, the variable damping system 122 includes an expandable bladder 124 that is positioned between the power cell 118 and an underside 126 of the mounting bracket 110. The expandable bladder 124 is configured to maintain a pre-determined volume of pressurized fluid therein. In one embodiment, the pressurized fluid may be air. In another embodiment, the pressurized fluid may be a gas, for e.g., nitrogen. In an alternative embodiment, the pressurized fluid may be a liquid, for e.g., oil having suitable characteristics and/or of a specific grade for the required application. Optionally, the pressurized fluid disclosed herein, may also be a mixture containing air, gases, and/or liquids. For example, in one application, it may be helpful to use a mixture of nitrogen and a specific type of oil as the pressurized fluid.

In various embodiments disclosed herein, it may be noted that the exact specifications of the pressurized fluid may vary from one type and/or configuration of hydraulic hammer to another, and/or from one application to another depending on specific requirements of the associated application. Therefore, any type of fluid may be used to form the pressurized fluid disclosed herein without deviating from the scope of the present disclosure.

The variable damping system 122 may further include a pump 128. In an embodiment, the pump 128 may be disposed in fluid communication with the bladder 124. In another embodiment, an operator may fluidly couple the pump 128 to the bladder 124 when needed. The pump 128 is configured to supply the pre-determined volume of pressurized fluid to the bladder 124. As the pressurized fluid may include any type of fluid therein, a type of pump employed in the variable damping system 122 is suitably selected to correspond with the type of fluid being used in the bladder 124 of the hydraulic hammer 102. In an embodiment, the pump 128 may be configured to pressurize liquid phase alone. In another embodiment, the pump 128 may be configured to pressurize gaseous phase alone. In an alternative embodiment, the pump 128 may be of a type that is adapted to pressurize a mixture of liquid phase and gaseous phase.

In an embodiment as shown in FIG. 2, the variable damping system 122 may, optionally or additionally, include a pressure gauge 130. This pressure gauge 130 may be disposed between the pump 128 and the bladder 124 to display a pressure of the fluid being supplied to the bladder 124. Such information may assist the operator in operating the hydraulic hammer 102 with a desired amount of pressurized fluid in the bladder 124.

It is hereby envisioned that the pressurized fluid maintained in the bladder 124 will allow the bladder 124 to damp vibrations from the power cell 118 of the hydraulic hammer 102. This way, the vibrations from the power cell 118 may be prevented from entering into the control implement 112 (See FIG. 1) that is used by the operator to control functions of the hydraulic hammer 102.

Moreover, the expandable bladder 124 may be beneficially made from an elastomeric material such as Neoprene, Rubber, and other types of elastomers commonly known to one skilled in the art. The expandable nature of the bladder 124 may allow the operator to selectively switch the pump 128 “ON” or “OFF” and vary the amount of pressurized fluid in the bladder 124.

Depending on the amount of pressurized fluid maintained in the bladder 124, vibrations from the power cell 118 may be underdamped, critically damped, or overdamped. As such, an operator of the machine may pre-determine the amount of pressurized fluid that is to be maintained in the bladder 124 depending on the responsiveness of the hydraulic hammer 102 at the control implement 112 to the operator. For example, if the operator wishes to feel a significantly higher amount of vibrations when operating the control implement 112, he may choose to fill the bladder 124 with more fluid so as to underdamp the vibrations during operation of the hydraulic hammer 102. However, if the operator wishes to feel a moderate amount of vibrations at the control implement 112, he may choose to fill the bladder 124 with lesser fluid for a softer response to the vibrations. This way, the vibrations from the hydraulic hammer 102 may be critically damped or over damped and therefore, little or no vibrations may be experienced by the operator when operating the control implement 112.

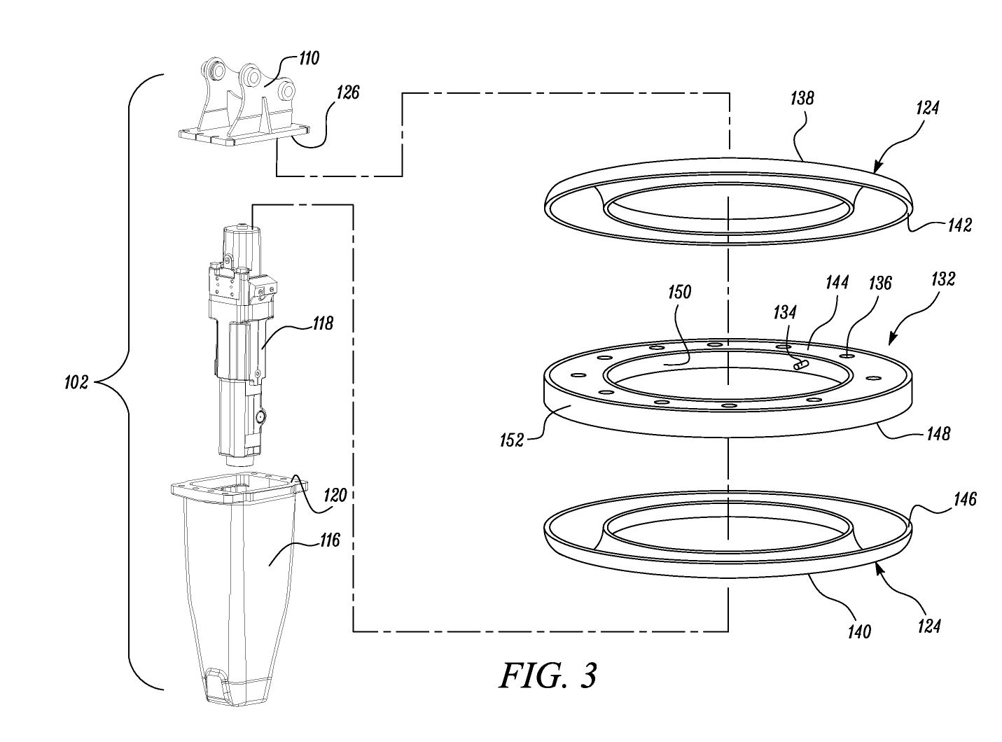

In an embodiment as shown in FIG. 3, the variable damping system 122 may further include a retainer 132 that is associated with the bladder 124. The retainer 132 may be configured to retain a form and fit of the expandable bladder 124 within the housing 116 of the hydraulic hammer 102. As shown, the retainer 132 is in the shape of an annular rim. In an example, the retainer 132 may be made of metal. In other examples, the retainer 132 may be made of other materials such as fibre glass to suit a specific requirement of the application.

The retainer 132 includes at least one port 134 that is disposed in fluid communication with the expandable bladder 124. In the illustrated embodiment, the retainer 132 includes one port 134. The port 134 may be configured to receive a supply of the pressurized fluid and discharge the pressurized fluid into the bladder 124. The port 134 may be fluidly coupled to the pump 128 to receive the supply of the pressurized fluid. The port 134 may also be configured to allow a discharge of the pressurized fluid from the bladder 124.

Further, as shown in the illustrated embodiment of FIG. 3, the bladder 124 includes a top portion 138 and a bottom portion 140. The top portion 138 has a first rimmed end 142 that is configured to engage with a top side 144 of the retainer 132 while the bottom portion 140 has a second rimmed end 146 that is configured to engage with a bottom side 148 of the retainer 132. Each of the top portion 138 and the bottom portion 140 of the bladder 124 is annular in shape to conform to the annular shape of the retainer 132. In such a case, the retainer 132 may further include at least one vent port 136 to allow a passage of the pressurized fluid received via the port 134 to both the top portion 138 and the bottom portion 140 of the bladder.

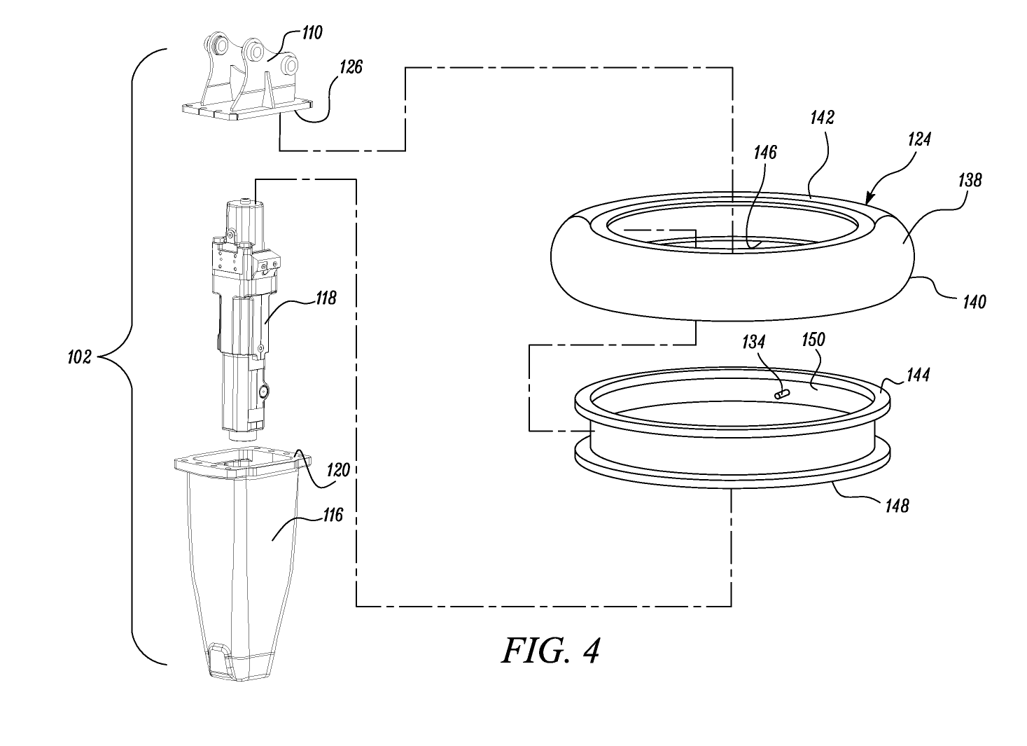

In another embodiment as shown in FIG. 4, the retainer 132 may be configured such that the port 134 is located on an inner surface 150 similar to that shown in the illustrated embodiment of FIG. 3. Moreover, as shown in the illustrated embodiment of FIG. 4, the top portion 138 of the bladder 124 and the bottom portion 140 of the bladder 124 may be integral with one another so as to impart a unitary construction to the bladder 124.

Various embodiments disclosed herein are to be taken in the illustrative and explanatory sense, and should in no way be construed as unduly limiting of the present disclosure. All directional references (e.g., above, below, upper, lower, top, bottom, vertical, horizontal, inward, outward, radial, upward, downward, left, right, leftward, rightward, clockwise, and counter-clockwise) are only used for identification purposes to aid the reader's understanding of the present disclosure, and may not create limitations, particularly as to the position, orientation, or use of the systems and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The variable damping system 122 of the present disclosure has applicability in damping vibrations experienced during operation of hydraulic hammers.

In an aspect of the present disclosure, the bladder 124 of the present disclosure is configured to maintain varying amounts of pressurized fluid therein so as to accomplish a varying amount of damping i.e., underdamping, overdamping, and critically damping, to the vibrations from the hydraulic damper. This ability to adjust i.e., increase or decrease the amount of damping to the vibrations allows an operator of a machine with improved flexibility to choose the amount of vibrations experienced at the control implement 112. This way, the control implement 112 may be imparted with an operator-desired amount of vibration that allows for better handling of the control implement 112 by the operator.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A variable damping system for a power cell of a hydraulic hammer, the hydraulic hammer having a housing and a mounting bracket disposed on a top side of the housing, the variable damping system comprising:
an expandable bladder positioned between the power cell and an underside of the mounting bracket, the expandable bladder configured to:
receive a supply of pressurized fluid; and
maintain a pre-determined volume of pressurized fluid therein.

2. The variable damping system of claim 1 further comprising a pump disposed in fluid communication with the expandable bladder, the pump configured to supply the pre-determined volume of pressurized fluid to the expandable bladder.

3. The variable damping system of claim 1 further comprising a retainer associated with the expandable bladder, the retainer configured to retain a form and fit of the expandable bladder within the housing.

4. The variable damping system of claim 3, wherein the retainer comprises at least one port disposed in fluid communication with the expandable bladder, the at least one port configured to:
receive the supply of pressurized fluid; and
discharge the pressurized fluid into the expandable bladder.

5. The variable damping system of claim 3, wherein the retainer is in the shape of an annular rim.

6. The variable damping system of claim 1, wherein a shape of the expandable bladder is annular.

7. The variable damping system of claim 3, wherein the expandable bladder comprises:
a top portion having a first rimmed end configured to engage with a top side of the retainer; and
a bottom portion having a second rimmed end configured to engage with a bottom side of the retainer.

8. The variable damping system of claim 2, wherein the pump is configured to pump at least one of a liquid phase, a gaseous phase, and a combination thereof.

9. The variable damping system of claim 1, wherein the pressurized fluid is at least one of air, gas, and liquid.

10. The variable damping system of claim 1, wherein the pressurized fluid includes at least one of nitrogen and oil.

11. A hydraulic hammer comprising:
a housing;
a mounting bracket disposed on a top side of the housing;
a power cell disposed within the housing; and
a variable damping system for damping vibrations during operation of the power cell, the variable damping system comprising:
an expandable bladder positioned between the power cell and an underside of the mounting bracket, the expandable bladder configured to:
receive a supply of pressurized fluid; and
maintain a pre-determined volume of pressurized fluid therein.

12. The hydraulic hammer of claim 11, wherein the variable damping system further comprises a pump disposed in fluid communication with the expandable bladder, the pump configured to supply the pre-determined volume of pressurized fluid to the expandable bladder.

13. The hydraulic hammer of claim 11, wherein the variable damping system further comprises a retainer associated with the expandable bladder, the retainer configured to retain a form and fit of the expandable bladder within the housing.

14. The hydraulic hammer of claim 13, wherein the retainer comprises at least one port disposed in fluid communication with the expandable bladder, the at least one port configured to:
receive the supply of pressurized fluid; and
discharge the pressurized fluid into the expandable bladder.

15. The hydraulic hammer of claim 10, wherein a shape of the expandable bladder is annular.

16. The hydraulic hammer of claim 13, wherein the expandable bladder comprises:
a top portion having a first rimmed end configured to engage with a top side of the retainer; and
a bottom portion having a second rimmed end configured to engage with a bottom side of the retainer.

17. A machine for penetrating work surfaces, the machine comprising:
a hydraulic hammer having a power cell enclosed within a housing, the hydraulic hammer further comprising a mounting bracket disposed on a top side of the housing;
a control implement coupled to the power cell of the hydraulic hammer, the control implement operable to control functions of the hydraulic hammer;
a variable damping system comprising:
an expandable bladder disposed between the power cell and an underside of the mounting bracket, the expandable bladder configured to maintain a pre-determined volume of pressurized fluid therein; and
a pump disposed in fluid communication with the expandable bladder, the pump configured to supply the pre-determined volume of pressurized fluid to the expandable bladder, wherein the variable damping system is configured to damp vibrations from the hydraulic hammer to the control implement in at least one of an underdamped state, a critically damped state, and an overdamped state.

18. The machine of claim 17, wherein the variable damping system further comprises a retainer associated with the expandable bladder, the retainer configured to retain a form and fit of the expandable bladder within the housing.

19. The machine of claim 18, wherein the retainer comprises at least one port disposed in fluid communication with the expandable bladder, the at least one port configured to:
receive the supply of pressurized fluid; and
discharge the pressurized fluid into the expandable bladder.

20. The machine of claim 18, wherein the expandable bladder comprises:
a top portion having a first rimmed end configured to engage with a top side of the retainer; and

21. a bottom portion having a second rimmed end configured to engage with a bottom side of the retainer.
